(19) United States
(12) Patent Application Publication
(10) Pub. No.: US 2003/0076550 A1
(43) Pub. Date: Apr. 24, 2003

(54) Document lid for imaging devices

(76) Inventors: Nigel M-F Cheung, Fort Collins, CO (US); Michael A. Tregoning, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/012,923

(22) Filed: Oct. 22, 2001

(51) Int. Cl. H04N 1/04

(52) U.S. Cl. 358/474

(57) ABSTRACT

A lid for an imaging device is disclosed. The lid comprises a cover and a reflector having a first side and a second side. The first side of the reflector is adapted to retain a first object to be imaged by the imaging device proximate to an imaging plate. The second side of the reflector is coupled to the cover, the cover being adapted to display at least a portion of a second object disposed between the cover and the reflector.

### TECHNICAL FIELD OF THE INVENTION

The present invention relates generally to the field of imaging devices, and more particularly to a document lid for such imaging devices.

### BACKGROUND OF THE INVENTION

Imaging devices, including, but not limited to, optical flatbed scanners, are used typically to obtain a digital image of an object. Flatbed scanners generally include an imaging plate and a document lid. The imaging plate is typically a transparent platen upon which the object to be scanned is placed and the document lid is used to cover the imaging plate and the object. The document lid generally includes a document reflector which presses the document to be imaged flat against the imaging plate to provide a better image.

Generally, the scanner is placed in close proximity to other electronic equipment in the work space. For example, the scanner may be coupled to a computer with a keyboard to allow manipulation of the scanned image. Furthermore, a printer may be coupled to the computer so that the scanned image may be printed. Other electronic equipment, such as a telephone, speakers, etc. may also be present in close proximity to the scanner. Thus, the workspace of the user of the scanner is frequently very limited.

### SUMMARY OF THE INVENTION

In accordance with an embodiment of the present invention, a lid for an imaging device is disclosed. The lid comprises a cover and a reflector having a first side and a second side. The first side of the reflector is adapted to retain a first object to be imaged by the imaging device proximate to an imaging plate. The second side of the reflector is coupled to the cover, the cover being adapted to display at least a portion of a second object disposed between the cover and the reflector.

In accordance with another embodiment of the present invention, an imaging device comprising an imaging plate and a lid is disclosed. The imaging plate is adapted to receive a first object to be imaged. The lid comprises a cover and a reflector, the reflector having a first side and a second side. The first side of the reflector is adapted to retain the first object proximate to the imaging plate of the imaging device and the second side of the reflector is coupled to the cover, the cover having an opening disposed therein forming a window adapted to display a second object disposed between the cover and the reflector.

### BRIEF DESCRIPTION OF THE DRAWINGS

For a more complete understanding of the present invention, the objects and advantages thereof, reference is now made to the following descriptions taken in connection with the accompanying drawings in which:

FIG. 1A is an isometric view of an imaging device of an embodiment of the present invention;

FIG. 1B is an exploded view of the imaging device of FIG. 1A;

FIG. 2 is a top plan view of a document lid of the imaging device of FIG. 1A; and

FIG. 3 is a bottom plan view of the document lid of the imaging device of FIG. 1A.

### DETAILED DESCRIPTION OF THE DRAWINGS

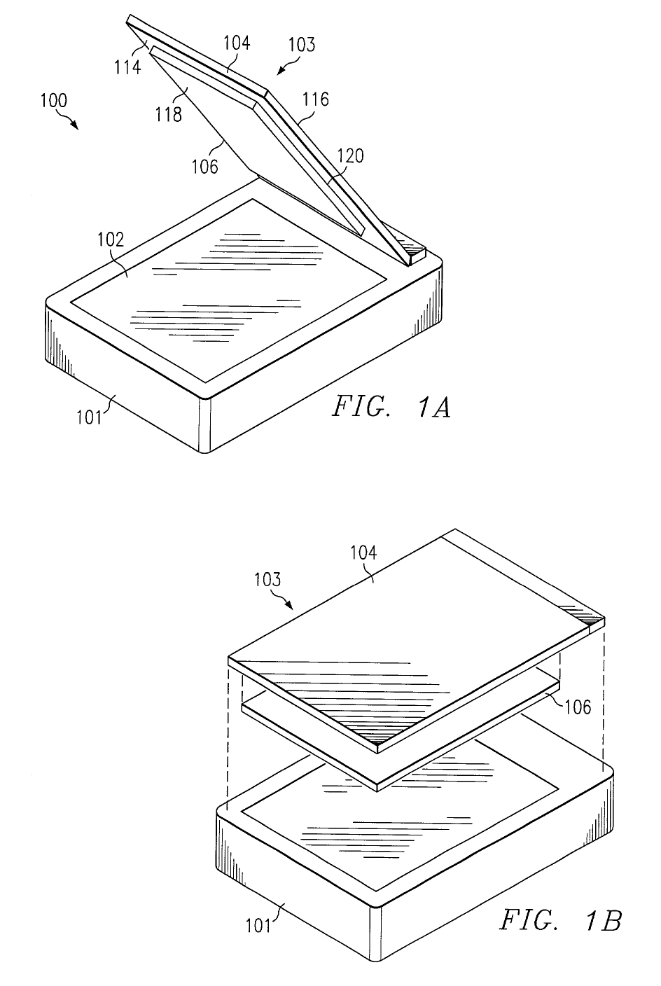

The preferred embodiment of the present invention and its advantages are best understood by referring to FIGS. 1 through 3 of the drawings, like numerals being used for like and corresponding parts of the various drawings.

An imaging device, such as a scanner, with a lid is disclosed. The lid of the imaging device comprises a cover and a reflector coupled to the cover. The cover is adapted to display an object, such as a document, inserted between the cover and the reflector.

FIG. 1A is an isometric view of an imaging device 100 of an embodiment of the present invention. FIG. 1B is an exploded view of imaging device 100 of FIG. 1A. The present invention will be described herein with reference to a scanner. However, the invention is not so limited and contemplates the use of the teachings of the present invention with respect to other imaging devices also, such as photocopiers, facsimile machines, printers and/or the like.

Imaging device 100 comprises a main body 101 and a document lid 103 coupled to main body 101. Main body 101 comprises an imaging plate 102 disposed along a top surface of main body 101. An object to be imaged may be placed on imaging plate 102. Document lid 103 is used to cover imaging plate 102 and the object placed on imaging plate 102. Document lid 103 comprises a document cover 104 and a document reflector 106. Document cover 104 has a first side 114 facing imaging plate 102 and a second side 116 facing away from imaging plate 102. Document reflector 106 has a first side 118 facing imaging plate 102 and a second side 120 coupled to first side 114 of document cover 104. Document reflector 106 presses the object to be imaged against imaging plate 102 to provide a better image.

Preferably, a carriage (not shown) disposed inside main body 101 of imaging device 100 supports one or more scanning devices or subsystems, such as a light source (not shown), an internal optical system (not shown) and a photosensitive device (not shown). The carriage is capable of moving along one or more support rails (not shown). As the carriage moves along the support rails, the light source radiates light that passes through imaging plate 102 and is reflected off the object placed thereon and/or document reflector 106. The reflected light is collected by the internal optical system and directed onto the photosensitive device. The photosensitive device converts the reflected light into one or more electrical signals.

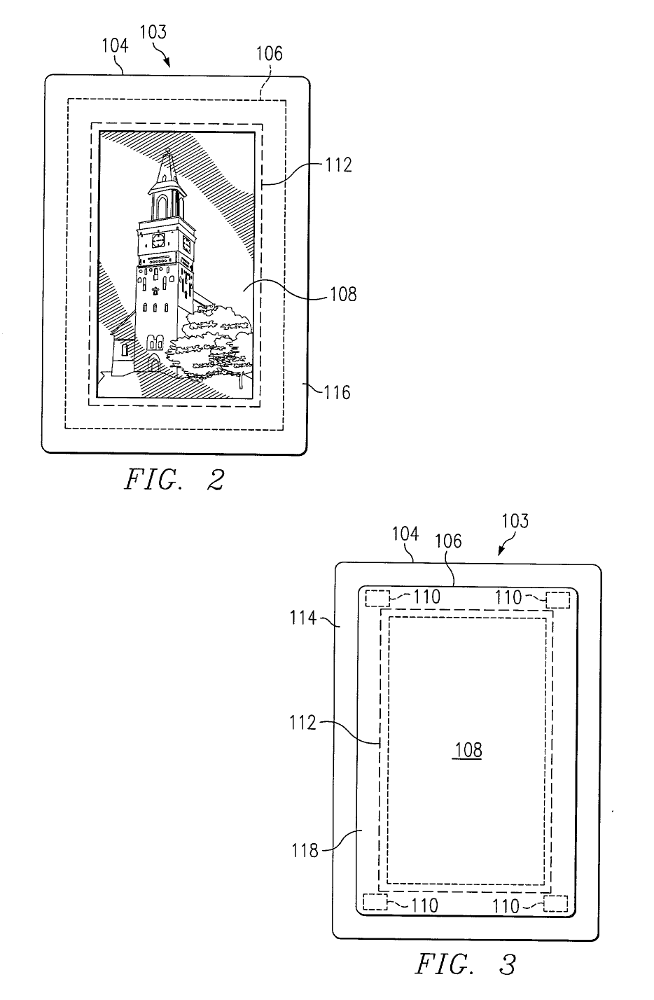

FIG. 2 is a top plan view of document lid 103 of imaging device 100. As shown, document cover 104 of document lid 103 includes a window 108 so that a user can see through the document cover. Window 108 is rectangular in shape. However, the invention is not so limited and window 108 may be any shape. The dimensions of window 108 are preferably smaller than document reflector 106. However, the invention is not so limited and window 108 may be the same size as or larger than document reflector 106.

Document reflector 106 is a conventional document reflector. However, unlike conventional document reflectors, document reflector 106 is removably attached to first side 114 of document cover 104 such that first side 118 of document reflector 106 faces imaging plate 102 and second side 120 of document reflector 106 faces first side 114 of document cover 104.

An object, such as, but not limited to, a poster, a photograph, needlepoint, construction paper, operating instructions for the scanner, a document, an advertisement, a flyer, a memorandum, a negative, a transparency, and/or the like may be placed between document cover 104 and document reflector 106 so that at least a portion of the front of the object is displayed through window 108 of document cover 104.

In the illustrated embodiment, document reflector 106 may be separated from document cover 104. The object may then be placed along first side 114 of document cover 104 along window 108 and document reflector 106 coupled to document cover 104 so that at least a portion of the front of the object is visible through window 108 of document cover 104. If desired, instead of placing the object along first side 114 of document cover 104, the object may be placed along second side 120 of document reflector 106 and document reflector 106 coupled to document cover 104 so that at least a portion of the front of the object is visible through window 108 of document cover 104.

If desired, document reflector 106 may be spaced apart from document cover 104 such that there is a cavity (not shown) between document cover 104 and document reflector 106. The object may be inserted in between document cover 104 and document reflector 106 through an opening (not shown) provided at one end of the cavity.

As shown in FIG. 2, when viewed from the top, at least a portion of the object that is placed between document cover 104 and document reflector 106 is visible through window 108 of document cover 104. A transparent sheet 112, such as a glass sheet, a plastic sheet, or any other transparent sheet substantially covering window 108, may be disposed between first side 114 of document cover 104 and second side 120 of document reflector 106. Transparent sheet 112 supports the object that is placed between document cover 104 and document reflector 106. Thus, if the object is not as large as window 108, transparent sheet 112 supports the object so that the object stays between document cover 104 and document reflector 106. If the object is not as large as window 108, a portion of second side 120 of document reflector 106 is also visible through window 108. As shown by dashed lines in FIG. 2, in the illustrated embodiment the boundary of document reflector 106 is not visible through window 108.

FIG. 3 is a bottom plan view of document lid 103 of imaging device 100. As shown in FIG. 3, when document lid 103 is viewed from the bottom, that is the side of document lid 103 facing imaging plate 102 of imaging device 100, window 108 is not visible. In the illustrated embodiment of FIG. 3, window 108 and transparent sheet 112 are substantially covered by document reflector 106. Document reflector 106 is coupled to document cover 104 by one or more coupling elements 110. Coupling element 110 is such that it allows coupling and removal of document reflector 106 to document cover 104. In the illustrated embodiment, sticking pads are used as coupling elements to couple document reflector 106 to document cover 104. If desired, other coupling elements, such as hook and loop segments, metal brads, screw and wing nuts, snaps, magnets, and other coupling elements now known or developed in the future, may be used in addition to or in place of sticking pads.

Although in the illustrated embodiment, four coupling elements 110 are shown, the invention is not so limited and if desired fewer or greater number of coupling elements may be used. Coupling elements 110 may be attached to first side 114 of document cover 104 such that they are not visible through window 108. A complementary portion of each coupling element may be attached to second side 120 of document reflector 106 so that document reflector 106 could be coupled to document cover 104. If desired, coupling element 110 may be attached only to second side 120 of document reflector 106 or only to first side 114 of document cover 104. Thus, for example, a first part of one or more sticking pads comprising of two parts each may be permanently attached to second side 120 of document reflector 106 (or first side 114 of document cover 104) while a second part of the sticking pads may be removably attached to first side 114 of document cover 104 (or second side 120 of document reflector 106).

An advantage of the illustrated embodiment of the present invention is that an object that provides useful information and/or is visually appealing may be placed between document cover 104 and document reflector 106 with at least a portion of the front of the object visible through window 108 of document cover 104. Thus, instead of positioning the object on a portion of a wall adjacent to imaging device 100 or instead of fastening the object to second side 116 of document cover 104 of imaging device 100, the object may be placed in document lid 103 itself, thereby providing more functionality to the document lid. Also, damage to the wall (or the surface of imaging device 100) that may be caused due to attaching the object to the wall (or the surface of imaging device 100) may be avoided. Moreover, because the object is placed between document reflector 106 and transparent sheet 112 of document cover 104, the likelihood of the object being damaged due to normal wear and tear is also reduced.

What is claimed is:

1. A lid for an imaging device, the lid comprising:
a cover; and
a reflector having a first side and a second side, the first side adapted to retain a first object to be imaged by the imaging device proximate to an imaging plate, the second side coupled to the cover, the cover being adapted to display at least a portion of a second object disposed between the cover and the reflector.

2. The lid of claim 1, wherein the reflector is removably coupled to the cover.

3. The lid of claim 1, wherein the cover has an opening disposed therein forming a window adapted to display the second object.

4. The lid of claim 3, further comprising a transparent sheet disposed over the window.

5. The lid of claim 1, further comprising at least one coupling element disposed on the cover for removably coupling said reflector to said cover.

6. The lid of claim 5, wherein said at least one coupling element comprises an element selected from the group consisting of a hook and loop pair, a metal brad, a screw and wing nut, a snap, a magnet and a sticking pad.

7. An imaging device, comprising:
an imaging plate adapted to receive a first object to be imaged; and
a lid having a first side and a second side, the first side adapted to retain the first object proximate to the imaging plate of the imaging device, the second side comprising a window adapted to display a second object disposed in the lid.

8. The imaging device of claim 7, wherein the lid comprises:
a cover having an opening disposed therein forming the window; and
a reflector coupled to the cover, the reflector disposed on the first side.

9. The imaging device of claim 8, wherein the reflector is removably coupled to the cover.

10. The imaging device of claim 7, further comprising a transparent sheet disposed over the window.

11. The imaging device of claim 7, wherein the lid comprises:
a cover having an opening disposed therein forming the window; and
a reflector coupled to the cover, the reflector disposed spaced apart from a portion of the cover forming a cavity adapted to receive the second object.

12. An imaging device, comprising:
an imaging plate adapted to receive a first object to be imaged; and
a lid comprising a cover and a reflector, the reflector having a first side and a second side, the first side adapted to retain the first object proximate to the imaging plate of the imaging device and the second side coupled to the cover, the cover having an opening disposed therein forming a window adapted to display a second object disposed between the cover and the reflector.

13. The imaging device of claim 12, further comprising a transparent sheet disposed between the cover and the reflector.

14. The imaging device of claim 12, wherein the window is substantially covered by the reflector on the side facing the imaging plate.

15. The imaging device of claim 12, wherein the reflector is removably coupled to the cover.

16. The imaging device of claim 12, further comprising at least one coupling element disposed on the cover, said at least one coupling element operable to removably couple said reflector to said cover.

17. The imaging device of claim 16, wherein said at least one coupling element is not visible through the window.
